(19) United States
(12) Patent Application Publication
(10) Pub. No.: US 2022/0297152 A1
(43) Pub. Date: Sep. 22, 2022

(54) ATOMIZATION DEVICE

(71) Applicant: FUNAI ELECTRIC CO., LTD., Osaka (JP)

(72) Inventor: Nobuyuki OKAZAKI, Osaka (JP)

(73) Assignee: FUNAI ELECTRIC CO., LTD., Osaka (JP)

(21) Appl. No.: 17/688,912

(22) Filed: Mar. 8, 2022

Related U.S. Application Data
(60) Provisional application No. 63/164,513, filed on Mar. 22, 2021.

(51) Int. Cl. B05B 17/06

(52) U.S. Cl. CPC B05B 17/0615

(57) ABSTRACT

An atomization device of the disclosure includes a main body and a tank assembly. The tank assembly includes a liquid supply tank, a support rod, a liquid supply core, and an elastic member. The liquid supply core penetrates an inward side of the support rod. The elastic member is positioned on a bottom surface of the liquid supply tank and has the liquid supply core disposed on the inward side of the support rod while being adjacent to the liquid suction end with a predetermined gap therebetween. The elastic member is constituted of a fixing part and a movable part which come into close contact with each other. The movable part is provided so as to be able to move forward and rearward with respect to the support rod via the elastic member.

### CROSS-REFERENCE TO RELATED APPLICATION

This application claims the priority benefit of US provisional Application No. 63/164,513, filed on Mar. 22, 2021. The entirety of the above-mentioned patent application is hereby incorporated by reference herein and made a part of this specification.

### BACKGROUND

### Technical Field

The disclosure relates to an atomization device.

### Description of Related Art

Regarding atomization devices, there is an atomization device as in the following.

In a sprayer in which a liquid inside a tank is sent to an ultrasound vibration piece by means of a felt water supply rod and it is sprayed due to vibration of a vibrator, there is a need to bias a tip of water absorption felt against the vibrator with a uniform force. In the technologies in the related art of Patent Document 1 to Patent Document 4, water absorption felt is surrounded by a guide pipe and a lower end of the water absorption felt is pushed upward from a lower end of the guide pipe using a compression coil spring so that an upper part of the felt at a standstill is pressed against a vibrator. In such technologies in the related art, one spiral spring is attached to the lower end of the water absorption felt, and an upper end and a lower end of the spring respectively abut the felt and the guide pipe.

However, in the foregoing technologies in the related art, there is room for improvement as in the following.

That is, a clearance corresponding to a length of a spring to be sandwiched therebetween is present between a lower end of water absorption felt and a bottom surface of a tank so that the water absorption felt cannot be extended to an area near the bottom surface of the tank, thereby causing a residual quantity of a liquid corresponding to the clearance which cannot be ultimately used. In addition, there has been a situation in which a liquid cannot be stably sent to a vibrator when the residual quantity of the liquid becomes low.

### Patent Documents

[Patent Document 1] Japanese Patent Laid-Open No. H06-320083

[Patent Document 2] Japanese Utility Model (Registered) Publication No. 3189058

[Patent Document 3] Japanese Patent Laid-Open No. 2010-214332

[Patent Document 4] Japanese Patent Laid-Open No. 2011-094846

[Patent Document 5] Japanese Patent Laid-Open No. 2007-203225

The disclosure provides an atomization device in which a liquid supply core is positionally limited to an elastic member via a particular elastic member, a lower end of the liquid supply core can approach a bottom surface of a liquid supply tank as far as possible, a liquid inside the liquid supply tank can be consequently used up as far as possible, and thus an ultimate residual quantity of the liquid can be reduced.

### SUMMARY

The disclosure provides an atomization device including a main body that has a vibrator, and a tank assembly that is provided so as to be able to be attached and detached with respect to the main body and is accommodated inside the main body in a coupled state of being attached to the main body. The tank assembly includes a liquid supply tank which has a space for holding a liquid; a support rod which is installed inside the liquid supply tank and is connected to the vibrator in the coupled state; a liquid supply core which is provided so as to penetrate an inward side of the support rod, which has a liquid suction end and a liquid atomization end, and in which the liquid atomization end is disposed adjacent to one side of the vibrator; and an elastic member which is disposed on a bottom surface of the liquid supply tank. The elastic member abuts the liquid suction end, so that the liquid supply core disposed inside the support rod and the elastic member with a predetermined gap between the support rod and the elastic member, and is constituted of a fixing part and a movable part which come into close contact with each other. The fixing part fixes the elastic member to the support rod. The movable part is provided so as to move adapted to forward and rearward with respect to the support rod.

According to the embodiment of the disclosure, the elastic member is a spring member constituted of winding parts having different diameters and coming into close contact with each other, and a diameter of the winding part constituting the fixing part is larger than a diameter of the winding part constituting the movable part.

According to the embodiment of the disclosure, a spiral shaped terminal end of the fixing part leads to a spiral shaped starting end of the movable part through a diameter-reduced connection part, and the diameter-reduced connection part is sandwiched between the fixing part and the movable part.

According to the embodiment of the disclosure, a lower end of the movable part is constituted of a wound portion supporting the liquid suction end.

According to the embodiment of the disclosure, the wound portion is spirally wound around in an axial direction of the movable part from a circumferential surface of the movable part.

According to the embodiment of the disclosure, while the main body and the tank assembly are in the coupled state, the movable part is in an extending state, the liquid suction end of the liquid supply core is positioned at a position close to the bottom surface of the liquid supply tank, and the liquid atomization end of the liquid supply core abuts the vibrator by a restoring force of the movable part. In addition, according to the embodiment of the disclosure, while the movable part is in the extending state, a distance between the wound portion and the bottom surface of the liquid supply tank is equal to or less than 2 mm.

According to the embodiment of the disclosure, the atomization device further includes a relay liquid supply core that is disposed between the liquid supply core and the vibrator. While the movable part is in the extending state, the liquid suction end comes into contact with the vibrator via the relay liquid supply core and atomizes the liquid by the vibrator.

According to the embodiment of the disclosure, the liquid supply core consists of a polyester fiber bundle. In addition, according to the embodiment of the disclosure, the liquid supply core is adhesive free.

According to the embodiment of the disclosure, the vibrator includes an upper lid and a base for fixing the vibrator to the main body, and a vibration piece which is disposed inside the upper lid and the base. The vibration piece comes into contact with the liquid supply core so as to atomize the liquid.

According to the embodiment of the disclosure, the main body further has a cavity part, and the vibrator is disposed above the cavity part.

### BRIEF DESCRIPTION OF THE DRAWINGS

FIG. 1A is an explanatory view of an appearance of an atomization device according to an embodiment of the disclosure.

FIG. 1B is an explanatory view when a tank assembly and a main body of the atomization device in FIG. 1A relatively slide.

FIG. 2A is an exploded explanatory view of the atomization device in FIG. 1A.

FIG. 2B is an exploded explanatory view of the atomization device in FIG. 1B.

FIG. 3 is an explanatory view of the tank assembly of the atomization device according to the embodiment of the disclosure.

FIG. 4A is an enlarged explanatory view of a region A in FIG. 3.

FIG. 4B is an explanatory view of an initial state of an elastic member in FIG. 4A.

FIG. 5A is an explanatory view of an initial state of an elastic member according to another embodiment of the disclosure.

FIG. 5B is an explanatory view of a state in which a force of the elastic member according to another embodiment of the disclosure is received.

FIG. 6 is a cross-sectional explanatory view of a coupled state of the atomization device.

FIG. 7A is an enlarged explanatory view of an area near a liquid suction end of a liquid supply core in the region A in FIG. 6.

FIG. 7B is a partial enlarged explanatory view of an area near a liquid atomization end of the liquid supply core in a region B in FIG. 6.

FIG. 8A is a perspective view of a structure of a vibrator according to the embodiment of the disclosure and is an explanatory view of an upper lid of the vibrator.

FIG. 8B is a perspective view of a structure of the vibrator according to the embodiment of the disclosure and is an explanatory view of a structure excluding the upper lid of the vibrator.

FIG. 9 is a cross-sectional view of the vibrator in FIGS. 8A and 8B.

FIG. 10A is an explanatory view of a standing upright-type usage state of an atomization device according to the embodiment of the disclosure.

FIG. 10B is an explanatory view of a horizontal usage state of an atomization device according to the embodiment of the disclosure.

### DESCRIPTION OF THE EMBODIMENT

According to the disclosure, it is possible to realize an atomization device in which while stable spraying is performed, a usage rate of a liquid is improved and a residual quantity of the liquid is sufficiently reduced.

Here, exemplary embodiments of the disclosure will be referred to in detail, and actual examples of the exemplary embodiments will be illustrated in the drawings. Whenever possible, the same members will be used in the drawings and description in order to indicate members which are the same or similar.

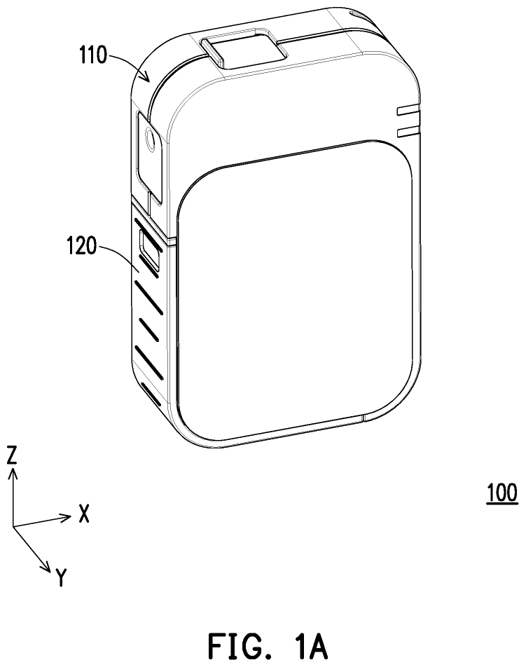

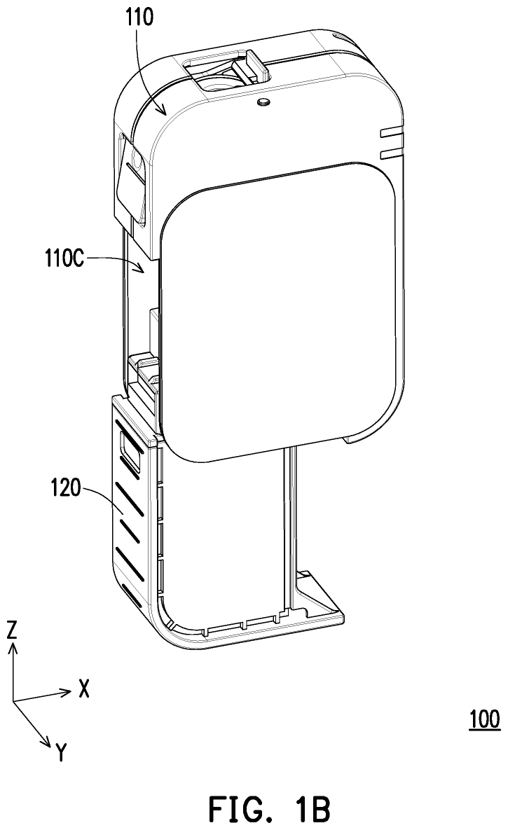

FIGS. 1A and 1B are an explanatory view of an appearance and an exploded explanatory view of an atomization device of an embodiment of the disclosure in different states. As illustrated in FIGS. 1A and 1B, an X direction, a Y direction, and a Z direction respectively indicate a width direction, a thickness direction, and a height direction of the atomization device.

FIG. 1A is an explanatory view of the appearance in a coupled state, and FIG. 1B is an explanatory view of a state when a tank assembly is detached from a main body. With reference to FIGS. 1A and 1B, an atomization device 100 includes a main body 110 and a tank assembly 120. The main body 110 has a cavity part 110C. As illustrated in FIG. 1B, the tank assembly 120 is provided so as to be able to be attached and detached with respect to the main body 110. In the present embodiment, for example, the tank assembly 120 slides in the Z direction with respect to the main body 110, but the disclosure is not limited thereto. While the main body 110 and the tank assembly 120 are in the coupled state, as illustrated in FIG. 1A, the tank assembly 120 can be accommodated in the cavity part 110C.

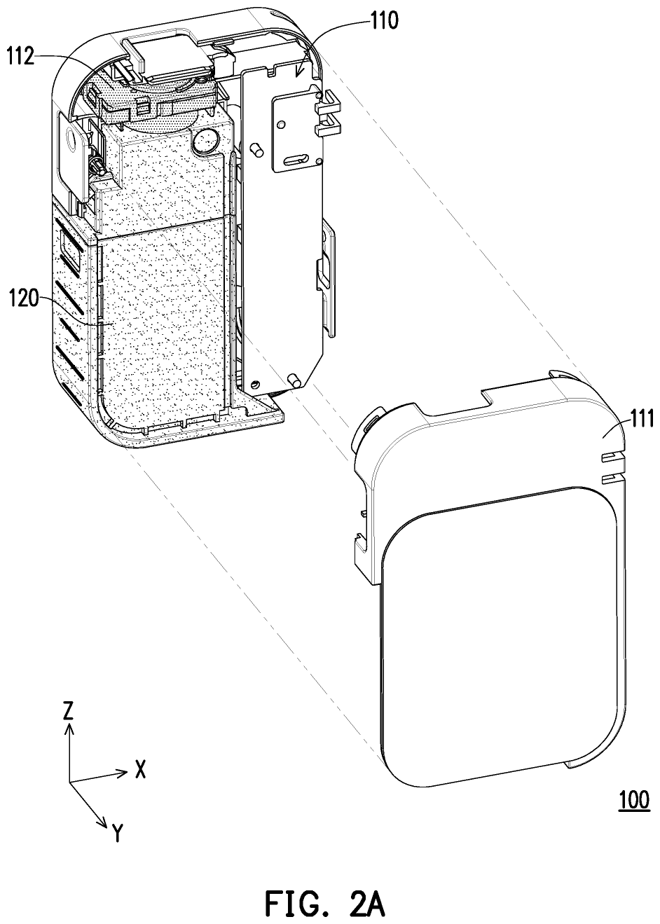

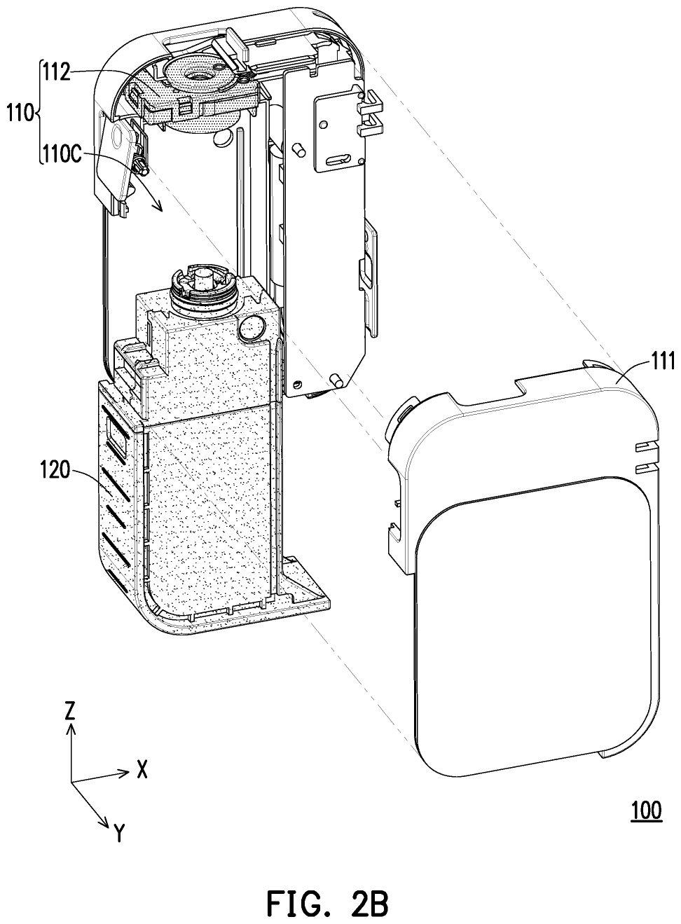

FIGS. 2A and 2B are exploded explanatory views of the atomization device in FIGS. 1A and 1B, respectively. As illustrated in FIG. 2B, the main body 110 of the atomization device 100 has a vibrator 112 and the cavity part 110C. The vibrator 112 is disposed above the cavity part 110C. While the tank assembly 120 and the main body 110 are in the coupled state, as illustrated in FIG. 2A, the tank assembly 120 abuts the vibrator 112. Hereinafter, the constitution of the tank assembly 120 and a relative positional relationship of the vibrator 112 will be described in detail.

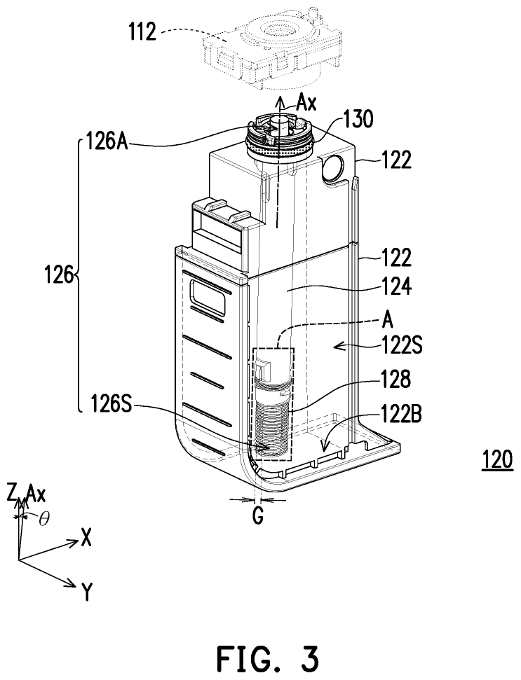

FIG. 3 is an explanatory view of the tank assembly of the atomization device according to the embodiment of the disclosure. The vibrator 112 thereabove is indicated by dotted lines in order to clearly illustrate the detailed structure of the atomization device. With reference to FIG. 3, the tank assembly 120 includes a liquid supply tank 122, a support rod 124, a liquid supply core 126, and an elastic member 128. The liquid supply tank 122 has a liquid holding space 122S for storing a liquid. For example, a material thereof is a thermoplastic polymer material, such as an acrylonitrile butadiene styrene (ABS) resin, which has a high strength and a strong toughness and with which processing, molding, and the like are easily performed, but the disclosure is not limited thereto. In the present embodiment, as illustrated in FIG. 3, the tank assembly 120 can further include a seal member 130, and the tank assembly 120 abuts the vibrator 112 due to the seal member 130. Moreover, the seal member 130 can prevent leakage of a liquid. For example, the seal member 130 is an O-ring. For example, a material thereof is a fluororubber. For example, a hardness thereof is C hardness 70. For example, a wire diameter thereof is ϕ1.5 mm. For example, a ring inner diameter thereof is ϕ13.5 mm.

With reference to FIG. 3, the support rod 124 is installed in the liquid supply tank 122, and an upper end thereof is connected to the vibrator 112. On the other hand, in the present embodiment, the support rod 124 has a tubular shape. The liquid supply core 126 is provided so as to penetrate an inward side of the support rod 124. The support rod 124 serves to support and hold the liquid supply core 126. In addition, a lower end of the support rod 124 serves to fix the elastic member 128. In this manner, the support rod 124 is fixed to the liquid supply tank 122 by means of an engagement part at the upper end. For example, a material of the support rod 124 is an ABS resin, such as an acrylonitrile butadiene styrene copolymer (ABS copolymer), that is, a thermoplastic polymer material, which has a high strength and a strong toughness and with which processing, molding, and the like are easily performed, but the disclosure is not limited thereto.

With reference to FIG. 3, the liquid supply core 126 has a liquid suction end 126S and a liquid atomization end 126A. The liquid atomization end 126A is disposed so as to be adjacent to one side of the vibrator 112. More specifically, in the coupled state, a liquid in the liquid supply tank 122 is supplied to the liquid atomization end 126A via the liquid suction end 126S of the liquid supply core 126, and the liquid is atomized due to vibration such as ultrasound vibration of a vibration piece inside the vibrator 112 and is sprayed from a spouting port. As illustrated in FIG. 3, the liquid supply core 126 is not straightly disposed inside the liquid supply tank 122. An angle of nip between an axial direction Ax of the liquid supply core 126 and the height direction Z when the liquid supply tank 122 is standing upright is approximately 2 degrees, for example. Accordingly, the atomization device can be secured such that a liquid does not remain at the time of horizontal usage, and this will be described later.

In addition, according to the embodiment of the disclosure, a material of the liquid supply core 126 can be constituted of only a polyester fiber bundle including no adhesive. Specifically, for example, regarding a method of manufacturing the liquid supply core 126, a plurality of thermoplastic polyester fibers is cured after being pressurized or heated, and composition components of the liquid supply core 126 include no adhesive. A porosity of the liquid supply core is 75%, for example. That is, from a microscopic viewpoint, the liquid supply core consists of only a plurality of polyester fiber bundles extending almost straightly along one axis. An extending length of each polyester fiber bundle corresponds to a distance from the liquid suction end 126S to the liquid atomization end 126A, and such a constitution can secure a liquid flowing along one axis inside the liquid supply core such that a flowing direction thereof is aligned with a fiber length direction. Therefore, compared to felt in technologies in the related art, since the atomization device of the disclosure uses a liquid supply core constituted of only polyester fiber bundles, the amount of elution of impurities is small. Therefore, a liquid can be more stably supplied to the vibrator 112.

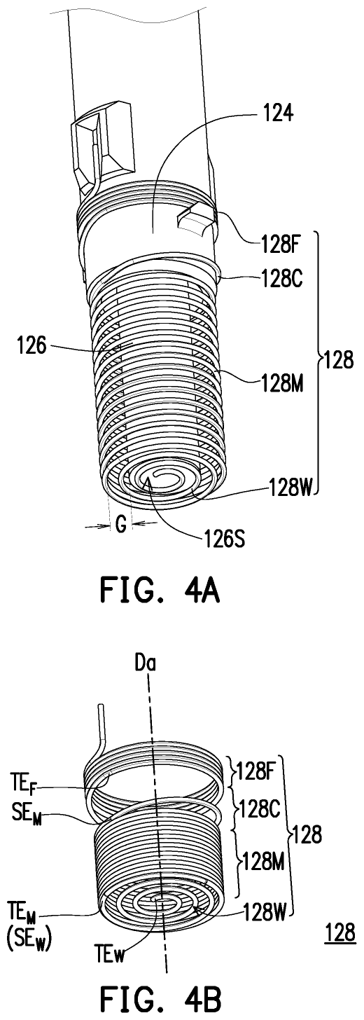

FIG. 4A further illustrates an enlarged explanatory view of a region A in FIG. 3. With reference to FIGS. 3 and 4A, the elastic member 128 is positioned on one side adjacent to a bottom surface 122B of the liquid supply tank 122. The elastic member 128 abuts the liquid suction end 126S and has the liquid supply core 126 disposed inside the support rod 124 and the elastic member 128 with a predetermined gap G therebetween. More specifically, since a movable part of the elastic member is held at the lower end of the support rod, the movable part can be disposed at a position on a side outward from an inner diameter of the support rod 124 and on a side inward from an outer diameter of the support rod 124.

As illustrated in FIGS. 3 and 4A, the predetermined gap G between the elastic member 128 and the liquid supply core 126 can be set within a range of 0.9 mm to 1.6 mm. In addition, the elastic member 128 abuts the liquid suction end 126S and positionally limits the liquid supply core 126 to the inside of the support rod 124 and the elastic member 128. In FIG. 4A, since the tank assembly 120 and the main body 110 are in the coupled state, the elastic member 128 is in an extending state. The elastic member 128 applies an elastic restoring force to the liquid supply core 126, biases the liquid supply core 126 against the vibrator 112 with a uniform load, and stably sprays a liquid. In the present embodiment, regarding a setting range of the predetermined gap G, in consideration of the following, for example, the smallest value of the predetermined gap G is set in consideration of a case in which the liquid supply core can be held inside the support rod 124 and the elastic member 128 at all times even if a dimensional error is present between the components or the assemblies. On the other hand, the largest value of the predetermined gap G is set in accordance with a numerical value obtained based on a tilt amount of the liquid supply core 126. For example, an embodiment of the predetermined gap G is shown in the following Table 1.

TABLE 1

| | | | Conversion | |
|---|---|---|---|---|
| | | Diameter | into radius | Remarks |
| Liquid supply core | Smallest | ϕ4.5 | R 2.25 | \textcircled{1} |
| | Largest | ϕ4.3 | R 2.15 | \textcircled{2} |
| | | ϕ4.7 | R 2.35 | |
| Inner diameter of support rod | | ϕ6.4 | R 3.20 | \textcircled{3} |
| Smallest predetermined gap (\textcircled{3}-\textcircled{2}) | | | | 0.85 |
| Outer diameter of support rod | | ϕ8.2 | R 4.10 | |
| Spring wire diameter | | ϕ0.3 | | |
| Inward side by spring wire diameter | | | R 3.80 | \textcircled{4} |
| Largest predetermined gap (\textcircled{4}-\textcircled{1}) | | | | 1.65 |

In the present embodiment, for example, the smallest value in the setting range of the predetermined gap G is 0.9 mm, and for example, the largest value is 1.8 mm and is more preferably 1.3 mm.

FIG. 4B is an explanatory view of an initial state of the elastic member in FIG. 4A. With reference to FIGS. 4A and 4B, the elastic member 128 is constituted of a fixing part 128F and a movable part 128M which come into close contact with each other, and the fixing part 128F fixes the elastic member 128 to the support rod 124. In the disclosure, a lower end of the movable part 128M is constituted of a wound portion 128W supporting the liquid suction end 126S, that is, a lower end of the movable part 128M is sealed by the wound portion 128W.

Specifically, the movable part 128M is provided so as to be able to move forward and rearward with respect to the support rod 124 via the elastic member 128. For example, FIG. 4A is an explanatory view of the extending state when the movable part 128M moves forward with respect to the support rod 124 via the elastic member 128, and FIG. 4B is an explanatory view of the movable part 128M returning to the initial state. That is, when the tank assembly 120 is separated from the main body 110, the elastic member 128 inside the tank assembly 120 returns to the initial state as illustrated in FIG. 4B. In addition, as illustrated in FIGS. 4A and 4B, in the present embodiment, the elastic member 128 is one spring member constituted of winding parts having two different diameters and coming into close contact with each other. A diameter of the winding part constituting the fixing part 128F is larger than a diameter of the winding part constituting the movable part 128M.

Description will be given with an example. For example, the elastic member 128 of the present embodiment is constituted of two tension coil springs having different diameters and coming into close contact with each other. Regarding wire diameters and loads of the springs, in consideration of a load applied to the vibrator of the atomization device and reduction in variation of the load, appropriate wire diameters and spring constants of the springs can be set. For example, in consideration on the basis of a required load and variation of the load (Expression (1)), the wire diameters of the springs are preferably ϕ0.3 mm to ϕ0.5 mm, and it is preferable to lower the spring constants by reducing the wire diameters. In the present embodiment, the wire diameters thereof are ϕ0.3 mm.

$$k = \frac{G \cdot {d}^{4}}{8 \cdot {N}_{α} \cdot {D}^{3}} \qquad ( 1 )$$

In Expression (1), G indicates a modulus of longitudinal elasticity, d indicates a wire diameter, Nₐ indicates an effective number of windings, and D indicates an inner diameter of a coil. In addition, for example, the loads of the springs are 5 gf to 20 gf. In the present embodiment, for example, the loads thereof are 10 gf. For example, materials of the springs are SUS 304WPB and can have corrosion resistance. Winding directions of the springs can be determined based on assembling processability with respect to the support rod 124. In the present embodiment, for example, dextral winding is adopted, but the disclosure is not limited thereto. In addition, regarding the diameters and the moduli of elasticity of the fixing part 128F and the movable part 128M, in addition to the consideration described above, they can be determined based on a size and a material of the support rod 124, and user's ability for disassembling and assembling. For example, the inner diameter of the fixing part 128F has a size such that the elastic member 128 can be fixed to an outer circumferential surface of a bottom part of the support rod 124. For example, the outer diameter of the movable part 128M is between the inner diameter and the outer diameter of the support rod 124. Consequently, one end of the movable part abuts a bottom circumferential surface of the support rod 124. For example, the diameters of the fixing part 128F and the movable part 128M are ϕ8.1 mm and ϕ7.3 mm, respectively. The diameter ratio of the movable part 128M and the fixing part 128F is 1:0.9, for example. In the present embodiment, setting of the movable part 128M and the fixing part 128F can be described as follows, but the disclosure is not limited thereto.

[Fixing part] In order to be wound around and fixed to the support rod, the inner diameter of the fixing part is set to be slightly smaller than the outer diameter of the support rod. For example, the inner diameter of the fixing part is set to ϕ8.1 mm with respect to the outer diameter of ϕ8.2 mm.

[Movable part] In order to prevent the liquid supply core from coming into contact with the coil, the inner diameter of the movable part is set to be larger than the inner diameter of the support rod. For example, inner diameter of the movable part is set to ϕ7.3 mm with respect to ϕ6.4 mm of the inner diameter of the support rod.

Specifically, in the present embodiment, as illustrated in FIG. 4B, a spiral shaped terminal end TE_{F} of the fixing part 128F is connected to a spiral shaped starting end SE_{M} of the movable part 128M via a diameter-reduced connection part 128C. The diameter-reduced connection part 128C surrounds the bottom part of the support rod 124 and sandwiches the support rod 124 between the fixing part 128F and the movable part 128M. In the specification of this application, a so-called spring member having two different diameters and “coming into close contact with each other” indicates that the fixing part 128F and the movable part 128M are directly connected to each other. Alternatively, when the diameter-reduced connection part 128C is present, a length of one round is preferable for a winding length of the diameter-reduced connection part 128C from a viewpoint of uniformly holding the whole circumference. However, depending on the spring to be used, the length thereof may be constituted to obtain an appropriate connection state by shortening or lengthening the length, having the number of windings of two or more, or the like.

In addition, with reference to FIG. 4B, for example, the wound portion 128W is formed by being spirally wound on the same plane in an axial direction Da of the movable part 128M from a circumferential surface of the movable part 128M. Specifically, a spiral shaped terminal end TE_{M} of the movable part 128M becomes a spiral shaped starting end SE_{W} of the wound portion 128W. The wound portion 128W is formed by being wound so as to be gradually reduced in diameter in the axial direction Da of the movable part 128M on the same plane. As illustrated in FIG. 4B, a spiral shaped terminal end TE_{W} of the wound portion 128W is adjacent to a center axis Da of the elastic member 128, and the wound portion 128W is a flat winding spring, for example.

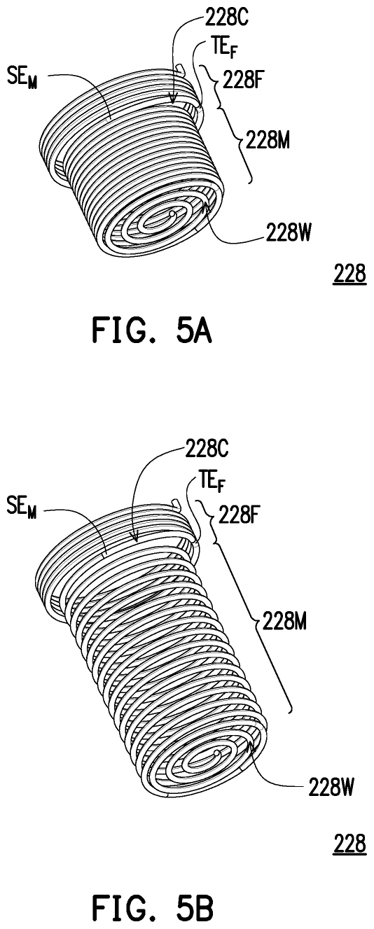

In the disclosure, the elastic member is not limited to the constitution forms in FIGS. 4A and 4B. The method of winding, the number of windings, the length, and the diameter of the fixing part and the movable part of the elastic member, and the connection relationship between the fixing part and the movable part are not limited. For example, the elastic member can be constituted as illustrated in FIGS. 5A and 5B. FIGS. 5A and 5B are explanatory views of an initial state of an elastic member according to another embodiment of the disclosure and a state in which a force is received. In the present embodiment, an elastic member 228 is constituted of a fixing part 228F, a movable part 228M, and a diameter-reduced connection part 228C between the fixing part 228F and the movable part 228M. The spiral shaped terminal end TE_{F} of the fixing part 228F leads to the spiral shaped starting end SE_{M} through the diameter-reduced connection part 228C. Compared to the elastic member 128 described above, in the elastic member 228 of the present embodiment, the fixing part 228F and the movable part 228M are closer to each other in the initial state, that is, the extending length of the diameter-reduced connection part 228C in the axial direction Da is shorter than the extending length of the diameter-reduced connection part 128C in the axial direction Da, but the disclosure is not limited thereto.

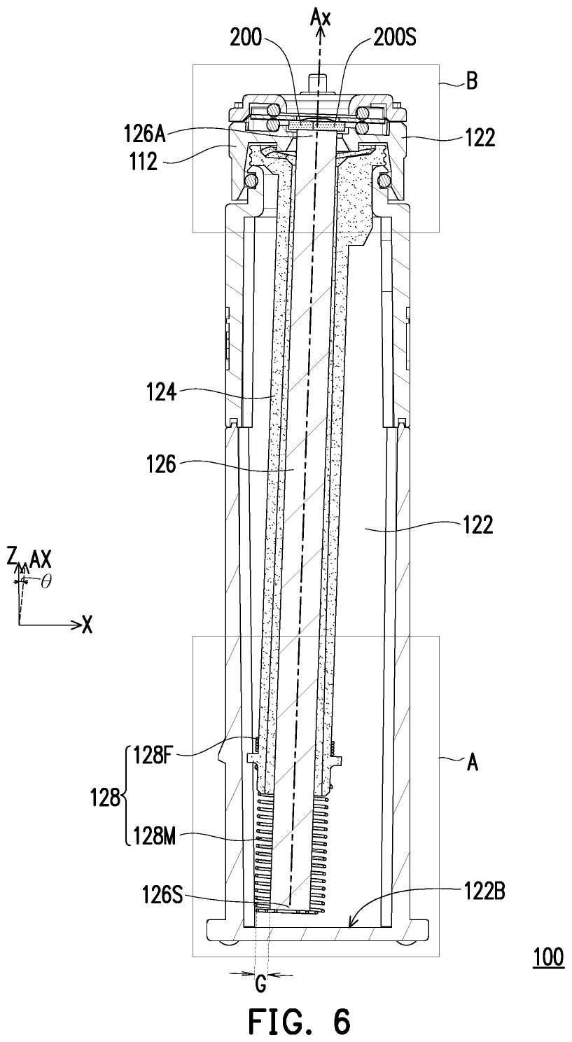

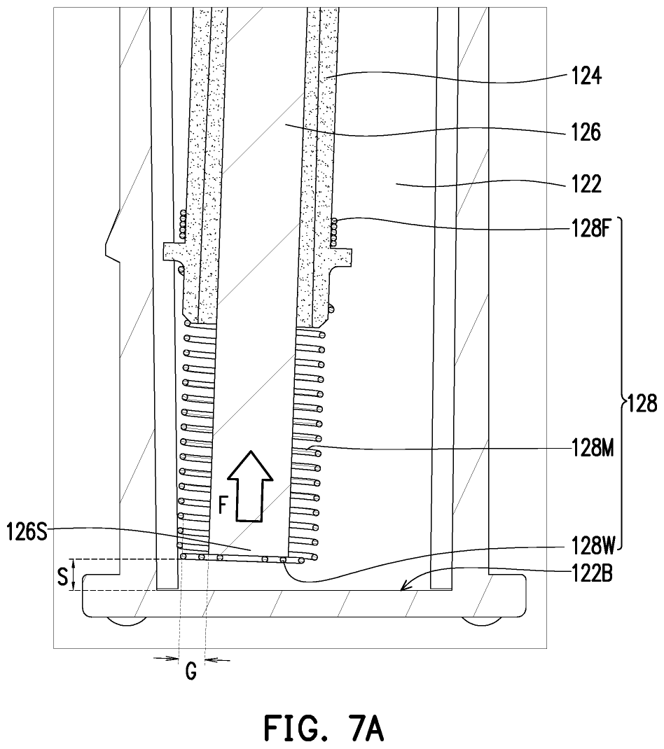

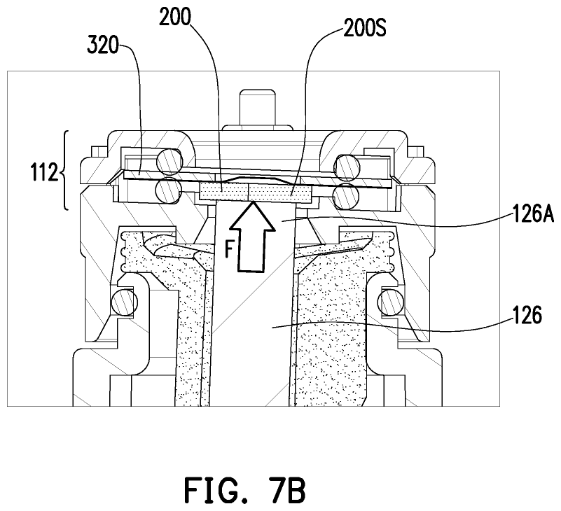

FIG. 6 is a cross-sectional explanatory view of the atomization device in an assembled state in an XZ direction. FIG. 7A is an enlarged explanatory view of an area near the liquid suction end of the liquid supply core in the region A in FIG. 6, and FIG. 7B is a partial enlarged explanatory view of an area near the liquid atomization end of the liquid supply core in a region B in FIG. 6. Hereinafter, in the atomization device of the disclosure on the basis of FIGS. 6, 7A, and 7B, a related mechanism of reducing a residual quantity of a liquid using an elastic member having a particular structure and supplying a liquid toward the vibrator will be described.

As illustrated in FIGS. 6, 7A, and 7B, a user applies a force to the tank assembly 120 and causes the tank assembly 120 to be fitted into the main body 110. While the main body 110 and the tank assembly 120 are in the coupled state, the movable part 128M receives a force and moves toward the bottom surface 122B of the liquid supply tank 122. At this time, the wound portion 128W at the lower end of the movable part 128M approaches the bottom surface 122B of the liquid supply tank 122 as far as possible, and the movable part 128M is in the extending state. For example, a distance S between the wound portion 128W and the bottom surface 122B of the liquid supply tank 122 is equal to or less than 2 mm and is more preferably equal to or less than 1 mm. Accordingly, even if a small amount of a liquid remains on the bottom surface 122B of the liquid supply tank 122, the liquid has surface tension with respect to a tube wall of the liquid supply tank 122 and on a boundary surface between the liquid and the wound portion 128W so that the small amount of the remaining liquid rises along the wound portion 128W, and thus it can be used more sufficiently. On the other hand, since the liquid suction end 126S of the liquid supply core 126 is adhered to the wound portion 128W due to a restoring force F of the spring member, a liquid which has risen to the wound portion 128W can be more reliably supplied to the liquid suction end 126S with which it comes into close contact, and thus the remaining liquid is stably supplied to the vibrator 112 via a fiber bundle allowing the liquid to flow along one axis inside the liquid supply core.

In the constitution of the present embodiment, in order to allow a liquid in the atomization device to be used more completely, the height of the residual quantity of a liquid inside the liquid supply tank 122 can be smaller than the distance S between the wound portion 128W and the bottom surface 122B. Meanwhile, considering manufacturing tolerance of the spring and the tank assembly, it is preferable to have a clearance between the wound portion 128W, the bottom side of the liquid supply tank 122, and the bottom surface 122B of the liquid supply tank 122. Accordingly, occurrence of friction between the elastic member 128 and the tank assembly 120 can be avoided. Accordingly, a liquid inside the liquid supply tank can be fully used as far as possible, and the residual quantity of the liquid can be reduced. A liquid remaining inside the tank has a height of 2 mm from the bottom surface at most, and it is approximately 0.9 ml in terms of quantity. Accordingly, a liquid remaining on the bottom surface of the liquid supply tank rises from the wound portion to the liquid suction end of the liquid supply core due to surface tension between the liquid and the wound portion so that it can be sufficiently utilized.

The expression “approach the bottom surface of the liquid supply tank as far as possible” described in the specification of this application indicates that a liquid remaining inside the tank is 1 ml at most and the height is 2 mm at most. Moreover, due to a synergistic effect of the elastic member and the liquid supply core, a liquid can be stably supplied to the vibrator so that spraying can be stably performed. In addition, the atomization device of the disclosure can perform not only standing upright-type spraying but can also perform horizontal-type spraying.

Meanwhile, regarding the liquid atomization end 126A of the liquid supply core 126, as illustrated in FIGS. 6 and 7B, the liquid atomization end 126A of the liquid supply core 126 also abuts the vibrator 112 upon reception of action of the restoring force F of the elastic member 128. A liquid sent by the liquid supply core 126 is stably adhered to the vibrator 112, and the liquid is atomized by a vibration piece 320 of the vibrator 112. From the above, the atomization device of the disclosure stably performs cooperative action with the liquid supply core 126 due to the elastic member 128 having a particular structure. Consequently, it is ascertained that a liquid can be stably supplied to the vibrator 112 and spraying can be stably performed.

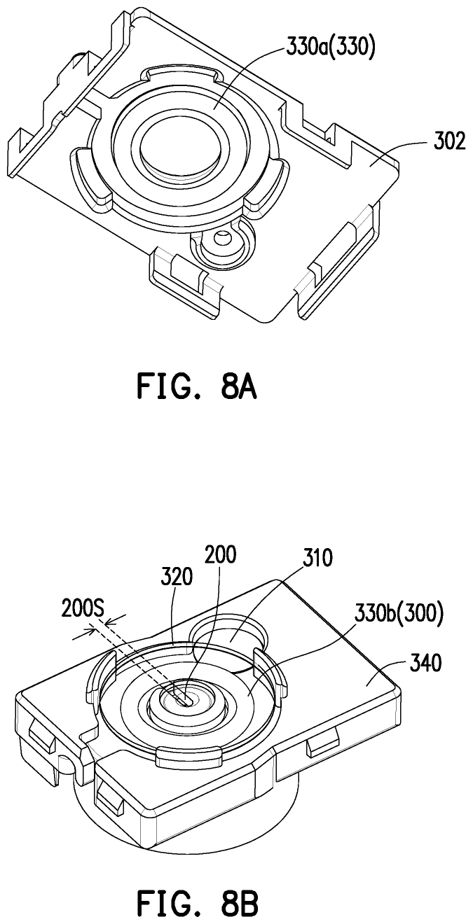

In addition, as illustrated in FIG. 7B, the atomization device according to the embodiment of the disclosure can further include a relay liquid supply core 200 that is provided between the liquid supply core 126 and the vibrator 112. The relay liquid supply core 200 serves as a buffer relay station which retains a liquid suctioned up from the liquid supply core 126 therein and stably supplies the liquid to the vibrator. Water is an example of a liquid, and the relay liquid supply core 200 has water retention performance and can stably supply water to the vibrator 112 without interruption. Therefore, stability of liquid atomization can be further improved and spraying can be performed stably and continuously by adding the relay liquid supply core 200. In addition, regarding a layout of the liquid supply core 126, in consideration of increase in a water supply amount, the size of the liquid supply core 126 can be set to be smaller than the largest diameter of a diameter range of the relay liquid supply core 200. In addition, in the present embodiment, as illustrated in FIGS. 6 and 7B, the right half part of the relay liquid supply core 200 has a slit 200S, and a length of the slit 200S can extend from the circumferential surface to the center. A detailed structure can be referred to FIG. 8B.

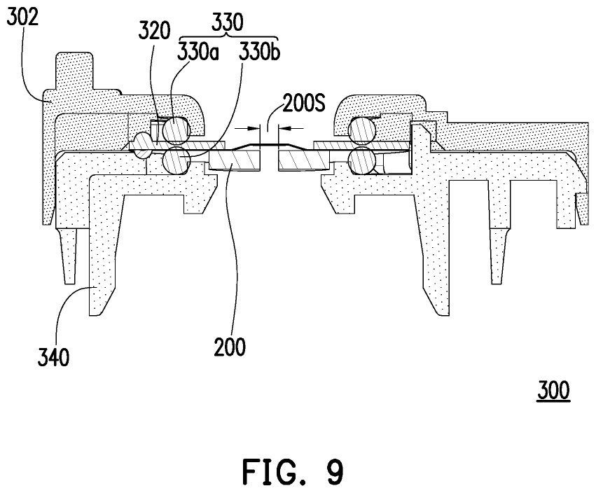

FIGS. 8A and 8B are perspective views of a structure of the vibrator according to the embodiment of the disclosure. FIG. 8A is an explanatory view of an upper lid of the vibrator, and FIG. 8B is an explanatory view of a structure of a base of the vibrator. FIG. 9 is a cross-sectional view along an axis of the vibrator in FIGS. 8A and 8B. In order to clearly illustrate a structure of the vibrator, unnecessary lines are omitted and only some members are depicted for description. With reference to FIGS. 8A, 8B, and 9, a vibrator 300 includes an upper lid 302, a base 340, and a seal member 330. The upper lid 302 is used for protecting the vibrator 300. As illustrated in FIG. 2B, the vibrator 300 is fixed to the main body 110 of the atomization device.

As illustrated in FIGS. 8A and 9, a seal member 330a is provided in the upper lid 302, and a seal member 330b, a tank internal pressure adjustment seat 310 and the relay liquid supply core 200 are provided in the base 340. The upper lid 302 and the base 340 are fixed at three positions by snap-fitting. The vibration piece 320 is sandwiched between the upper lid 302 and the base 340. The base 340 performs pressure adjustment inside the liquid supply tank 122 by means of the tank internal pressure adjustment seat 310. For example, the vibration piece 320 is an ultrasound vibration piece using a piezoelectric vibration piece and atomizes a liquid due to extending vibration of the vibration piece. The base 340 protects the vibrator 300, prevents a water leak of the liquid supply tank 122, and is used for fixing the vibrator 300 to the main body 110 of the atomization device as illustrated in FIG. 2B. As illustrated in FIGS. 8B and 9, the base 340 has the vibration piece 320 sandwiched between the base and the upper lid 302 by means of the seal member 330b positioned below the vibration piece 320. The seal member 330b further performs action of preventing a water leak of the liquid supply tank 122. In the present embodiment, materials of the upper lid 302 and the base 340 are polyoxymethylene (POM), for example.

The seal members 330a and 330b are used for maintaining the relative positional relationship between the vibration piece 320, the upper lid 302, and the base 340, has a waterproof effect, prevents a liquid from scattering to the outside, and improves efficiency of atomizing liquid. For example, the seal members 330a and 330b are O-rings. For example, materials thereof are silicone rubber. In the present embodiment, for example, the hardness of the seal members 330a and 330b is C hardness of 50, for example, the wire diameter is ϕ1.5 mm, and for example, the ring inner diameter is ϕ8.5 mm, but the disclosure is not limited thereto.

In the atomization device of the present embodiment, a relative positional relationship when the atomization device further includes the relay liquid supply core 200 is illustrated. However, in the atomization device of the disclosure, installation of the relay liquid supply core 200 can also be omitted, but the disclosure is not limited thereto. When the atomization device does not include the relay liquid supply core 200, the liquid atomization end 126A of the liquid supply core 126 and the vibration piece 320 described above are adjacent to each other.

In the embodiment including a relay liquid supply core, the plan view of the relay liquid supply core 200 becomes as illustrated in FIG. 8B and has the slit 200S. The slit 200S can extend from the circumferential surface of the relay liquid supply core 200 to the center point of the relay liquid supply core 200. The length of the slit 200S becomes substantially equivalent to the radius of the relay liquid supply core 200. The cross-sectional position in FIG. 9 is aligned on a central cross section orthogonal to a length direction of the slit. Therefore, in FIG. 9, the width of the slit 200S in the relay liquid supply core 200 can be seen. In the cross-sectional view illustrated in FIG. 7B, marking of the slit 200S is omitted.

In the atomization device of in the disclosure, since the liquid supply core 126 can supply a liquid to the vibration piece even if the relay liquid supply core is omitted, spraying of the disclosure can be performed. In addition, in order to perform spraying more continuously, installation of the relay liquid supply core can be selectively added. In the embodiment including the relay liquid supply core 200, regarding the size of the relay liquid supply core 200, for example, the diameter is ϕ6.5 mm and the thickness is 1 mm. In the slit 200S, for example, the length is approximately 3.25 mm and the width approximately 1 mm. Even if air bubbles generated due to vibration of the vibration piece 320 during a spray process of the atomization device 100 are accumulated, a liquid supply amount is reduced, and spray ability deteriorates, air bubbles being accumulated can be reduced and can be smoothly discharged by providing the relay liquid supply core 200. As a result, liquid supply to the vibration piece can be further stabilized and continuous spraying can be realized. The material of the relay liquid supply core 200 can be a material having water absorption properties, chemical resistance, and softness. For example, the relay liquid supply core 200 can be a soft polyurethane sponge having a C hardness of approximately 7.

For example, in the present embodiment, when the relay liquid supply core is not present, the spray amount is approximately 7 ml/h. In contrast, when the relay liquid supply core is further added, the spray amount is approximately 23 ml/h, and improvement of approximately three times can be confirmed.

### Embodiment

In the atomization device 100 of the present embodiment, evaluation was performed by causing an atomization device including the foregoing constitution to perform standing upright-type spraying and horizontal-type spraying. In addition, the size of the used main body was 66 mm (length, X)×26 mm (width, Y)×101 mm (height, Z). In the used tank assembly 120, the size of the liquid supply tank 122 was 39 mm (length X)×21 mm (width Y)×83 mm (height Z), and the material thereof was ABS. The seal member 130 was an O-ring, the material thereof was a fluororubber, the hardness thereof was a C hardness of 70, the wire diameter was ϕ1.5 mm, and the ring inner diameter was ϕ13.5 mm. The material of the support rod 124 was ABS. Regarding the size, the inner diameter thereof was ϕ5.2 mm, and the tilt angle with respect to the Z direction was two degrees. The material of the liquid supply core 126 was constituted of a plurality of polyester fiber bundles including no adhesive and having a porosity of 75%. Regarding the size thereof, the diameter was ϕ4.5 mm. The material of the elastic member 128 was SUS 304WPB. A tension coil spring having a dextral winding constitution was used. The wire diameter thereof was 0.3 mm, and the load was 15 gf. The diameters of the fixing part 128F and the movable part 128M were ϕ8.1 mm and ϕ7.3 mm, respectively. The materials of the vibrator, the upper lid 302, and the base 340 to be used were POM. The hardness of the seal members 330a and 330b was the C hardness of 50, the wire diameter was ϕ1.5 mm, and the ring inner diameter was ϕ8.5 mm.

In the present embodiment, the relay liquid supply core 200 was installed. The material thereof was a polyurethane sponge. Regarding the size thereof, the diameter was 6.5 mm and the thickness was 1 mm. The relay liquid supply core 200 had the slit 200S having a width of approximately 1 mm.

### Effects of Present Embodiment

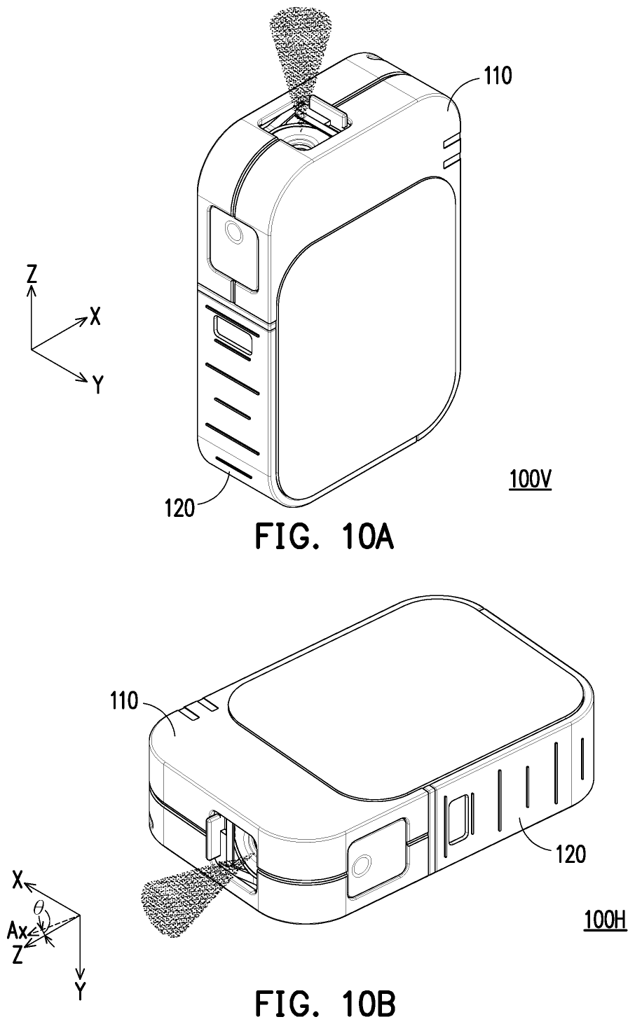

FIG. 10A is an explanatory view of a standing upright-type usage state of the atomization device according to the embodiment of the disclosure, and FIG. 10B is an explanatory view of a horizontal usage state of the atomization device according to the embodiment of the disclosure. FIG. 10A illustrates a standing upright-type spraying state of an atomization device 100V, and FIG. 10B illustrates a horizontal-type spraying state of an atomization device 100H.

According to the foregoing atomization device 100 which has been constituted as illustrated in FIGS. 1A to 9, due to cooperative action between the particular elastic member 128, the particular liquid supply core 126, and particular the vibrator 112 described above, both the standing upright-type atomization device 100V and the horizontal-type atomization device 100H can stably supply a liquid to the vibrator 112 and can stably perform spraying. In addition, as illustrated in FIG. 6, the axial direction Ax of the liquid supply core has an angle of nip larger than zero with respect to the Z direction, which is approximately 2 degrees, for example. Accordingly, when the atomization device performs horizontal-type spraying, a liquid does not remain and can be secured such that it can be stably sprayed.

Particularly, as in the present embodiment, the elastic member 128 is constituted of a spring member having two different diameters and coming into close contact with each other. The fixing part 128F having a comparatively large diameter is wound around the support rod 124, and the movable part 128M having a comparatively small diameter is constituted to extend from the lower end of the support rod 124 and to be able to move forward and rearward with respect to the support rod 124 via the elastic member 128. The lower end of the movable part 128M is constituted of the wound portion 128W supporting the liquid suction end 126S. Accordingly, the liquid supply core 126 positionally limited to the movable part 128M can arrive at a position closer to the bottom surface 122B of the liquid supply tank 122 as far as possible in accordance with the movable part 128M.

When the liquid supply core 126 moves downward, the movable part 128M is in the extending state. The wound portion 128W acts so as to be biased against the liquid supply core 126 with a uniform force using a restoring force of the elastic member 128. The liquid supply core 126 is closely sandwiched between the wound portion 128W and the vibrator 112. A liquid inside the liquid supply tank 122 can be stably supplied to the vibrator 112. When the relay liquid supply core 200 is provided, the function of stably supplying a liquid to the vibrator 112 can be further enhanced.

In addition, as illustrated in FIG. 6, by tilting the support rod 124 and the liquid supply core 126 inside the liquid supply tank 122, as illustrated in FIG. 10B, even if horizontal-type spraying is performed, a liquid close to the bottom surface of the liquid supply tank can be sufficiently used.

According to the aspect of the embodiment, as illustrated in FIGS. 10A and 10B, in the atomization devices 100V and 100H, a liquid remaining inside the liquid supply tank can be 1 ml at most, and the height can be 2 mm at most. In contrast, in the technologies in the related art, a liquid remaining in a tank corresponds to at least the length of a spring or longer. The atomization device of the disclosure can achieve a technical effect of effectively reducing the residual quantity of a liquid.

For last description, the foregoing embodiment is merely used for describing the technical idea of the disclosure, but it is not limited thereto. The disclosure has been described in detail with reference to the embodiment. However, the technical idea described in the embodiment can still be subjected to revision or replacement equivalent to some or all of technical features such that those skilled in the art can understand as a matter of course. However, revision or replacement does not cause the nature of the corresponding technical idea to depart from the scope of the technical idea of the examples of the disclosure.

What is claimed is:

1. An atomization device comprising:
a main body that has a vibrator; and
a tank assembly that is provided so as to be able to be attached and detached with respect to the main body and is accommodated inside the tank assembly in a coupled state of being attached to the main body,
wherein the tank assembly comprises:
a liquid supply tank which has a space for holding a liquid,
a support rod which is installed inside the liquid supply tank and is connected to the vibrator in the coupled state,
a liquid supply core which is provided so as to penetrate an inward side of the support rod, which has a liquid suction end and a liquid atomization end, and in which the liquid atomization end is disposed adjacent to one side of the vibrator, and
an elastic member which is disposed on a bottom surface of the liquid supply tank,
wherein the elastic member abuts the liquid suction end, so that the liquid supply core is disposed inside the support rod and the elastic member with a predetermined gap between the support rod and the elastic member, and is constituted of a fixing part and a movable part which come into close contact with each other,
wherein the fixing part fixes the elastic member to the support rod, and
wherein the movable part is provided so as to adapted to move forward and rearward with respect to the support rod.

2. The atomization device according to claim 1,
wherein the elastic member is a spring member constituted of winding parts having different diameters and coming into close contact with each other, and a diameter of the winding part constituting the fixing part is larger than a diameter of the winding part constituting the movable part.

3. The atomization device according to claim 2,
wherein a spiral shaped terminal end of the fixing part leads to a spiral shaped starting end of the movable part through a diameter-reduced connection part, and the diameter-reduced connection part is sandwiched between the fixing part and the movable part.

4. The atomization device according to claim 1,
wherein a lower end of the movable part is constituted of a wound portion supporting the liquid suction end.

5. The atomization device according to claim 4,
wherein the wound portion is spirally wound around in an axial direction of the movable part from a circumferential surface of the movable part.

6. The atomization device according to claim 1,
wherein while the main body and the tank assembly are in the coupled state, the movable part is in an extending state, the liquid suction end of the liquid supply core is positioned at a position close to the bottom surface of the liquid supply tank, and the liquid atomization end of the liquid supply core abuts the vibrator by a restoring force of the movable part.

7. The atomization device according to claim 6,
wherein a lower end of the movable part is constituted of a wound portion supporting the liquid suction end, and while the movable part is in the extending state, a distance between the wound portion and the bottom surface of the liquid supply tank is equal to or less than 2 mm.

8. The atomization device according to claim 6, further comprising:
a relay liquid supply core that is disposed between the liquid supply core and the vibrator,
wherein while the movable part is in the extending state, the liquid suction end comes into contact with the vibrator via the relay liquid supply core and atomizes the liquid by the vibrator.

9. The atomization device according to claim 1,
wherein the liquid supply core consists of a polyester fiber bundle.

10. The atomization device according to claim 9,
wherein the liquid supply core is adhesive free.

11. The atomization device according to claim 1,
wherein the vibrator comprises:
an upper lid and a base for fixing the vibrator to the main body, and
a vibration piece which is disposed inside the upper lid and the base, and
wherein the vibration piece comes into contact with the liquid supply core so as to atomize the liquid.

12. The atomization device according to claim 1,
wherein the main body further has a cavity part, and the vibrator is disposed above the cavity part.
